(19) United States
(12) Patent Application Publication
(10) Pub. No.: US 2004/0101204 A1
(43) Pub. Date: May 27, 2004

(54) Method of processing video into an encoded bitstream

(76) Inventor: Tony Richard King, Newnham (GB)

Correspondence Address: Richard C Woodbridge, Synnestvedt Lechner & Woodbridge, PO Box 592, Princeton, NJ, 08542-0592, US

(21) Appl. No.: 10/471,114

(22) PCT Filed: Feb. 28, 2002
(86) PCT No.: PCT/GB02/00881

(30) Foreign Application Priority Data
Mar. 7, 2001 (GB) 0105518.5
Dec. 4, 2001 (GB) 0128995.8

(51) Int. Cl. G06K 9/36

(52) U.S. Cl. 382/243; 382/240

(57) ABSTRACT

In a method of processing video into an encoded bitstream in which the encoded bitstream is intended to be sent over a WAN to a device, the processing of the video results in the bitstream (a) representing the video in a vector graphic format with quality labels which are device independent, and also (b) being decodable at the device to display, at a quality determined by the resource constraints of the device, a vector graphics based representation of the video.

### TECHNICAL FIELD

This invention relates to a method of a method of processing video into encoded bitstream. This may occur when processing pictures or video into instructions in a vector graphics format for use by a limited-resource display device.

### BACKGROUND ART

Systems for the manipulation and delivery of pictures or video in a scalable form allow the client for the material to request a quality setting that is appropriate to the task in hand, or to the capability of the delivery or decoding system. Then, by storing a representation at a particular quality in local memory, such systems allow the client to refine that representation over time in order to gain extra quality. Conventionally, such systems take the following approach: an encoding of the media is obtained by applying an algorithm whose parameters (e.g. quantisation level are set to some “coarse” level. The result is a bitstream which can be decoded and the media fully reconstructed, although at a reduced quality with respect to the original. Subsequent encodings of the input arc then obtained with progressively “better quality” parameter settings, and these can be combined with the earlier encodings in order to obtain a reconstruction to any desired quality.

Such a system may include a method for processing the image data into a compressed and layered form where the layers provide a means of obtaining and decoding data over time to build up the quality of the image. An example is described In PCT/GB00/01614 to Telemedia Limited. Here the progressive nature of the wavelet encoding in scale-space is used in conjunction with a ranking of wavelet coefficients in significance order, to obtain a bitstream that is scalable in many dimensions.

Such systems, however, make assumptions about the capabilities of the client device, in particular, as regards the display hardware, where the ability to render multi-bit pixel values into a framestore at video update rates, is usually necessary. At the extreme end of the mobile computing spectrum however, multi-bit deep framestores way not be available, or if they are, the constraints of limited connection capacity, CPU, memory, and battery life, make the rendering of even the lowest quality video a severe drain on resources. In order to address this problem a method of adapting the data to the capability of the client device is required. This is a hard problem in the context of video which is conventionally represented in a device-dependent low-level way, as intensity values with a fixed number of bits sampled on a rectangular grid. Typically, in order to adapt to local constraints, such material would have to be completely decoded and then reprocessed into a more suitable form.

A more flexible media format would describe the picture in a higher-level, more generic, and device-independent way, allowing efficient processing into any of a wide range of display formats. In the field of computer graphics, vector formats are well known and have been in use since images first appeared on computer screens. These formats typically represent the pictures as strokes, polygons, curves, filled areas, and so on, and as such make use of a higher-level and wider range of descriptive elements than is possible with the standard image pixel-format. An example of such a vector file format is Scalable Vector Graphics (SVG). If images can be processed into vector format while retaining (or even enhancing) the meaning or sense of the image, and instructions for drawing these vectors can be transmitted to the device rather than the pixel values (or transforms thereof), then the connection, CPU and rendering requirements potentially can all be dramatically reduced.

### SUMMARY OF THE INVENTION

In a first aspect, these is provided a method of processing video into an encoded bitstream in which the encoded bitstream is intended to be sent over a WAN to a device; wherein the processing of the video results in the bitstream

(a) representing the video in a vector graphic format with quality labels which are device independent, and

(b) being decodable at the device to display, at a quality determined by the resource constraints of the device, a vector graphics based representation of the video;

and in which the following steps occur as part of processing tie video into a vector graphics format with quality labels:

(i) describing the video in terms of vector based graphics primitives;

(ii) grouping these graphics primitives into features;

(iii) assigning to the graphics primitives and/or to the features values of perceptual significance;

(iv) deriving quality labels form these values of perceptual significance.

The quality labels may enable scalable reconstruction of the video at the device and also at different devices with different display capabilities. The method is particularly useful in devices which are resource constrained, such as mobile telephones and handheld computers.

An image, represented in the conventional way as intensity samples on a rectangular grid, can be converted into graphical form and represented as an encoding of a set of shapes. This encoding represents the image at a coarse scale but with edge information preserved. It also serves as a basic level image from which further, higher quality, encodings, are generated using one or more encoding methods. In one implementation, video is encoded using a hierarchy of video compression algorithms, where each algorithm is particularly suited to the generation of encoded video at a given quality level.

In a second aspect, there is a method of decoding video which has been processed into an encoded bitstream in which the encoded bitstream has been be sent over a WAN to device;

wherein the decoding of the bitstream involves (i) extracting quality labels which are device independent and (ii) enabling the device to display a vector graphics based representation of the video at a quality determined by the quality labels, so that the quality of the video displayed on the device is determined by the resource constraints of the device; and in which the following steps occurred as part of processing the video into a vector graphics format with quality labels:

(i) describing the video in terms of vector based graphics primitives;

(ii) grouping these graphics primitives into features;

(iii) assigning to the graphics primitives and/or to the features values of perceptual significance;

(iv) deriving quality labels from these values of perceptual significance.

In a third aspect, there is an apparatus for encoding video into an encoded bitstream in which the encoded bitstream is intended to be sent over a WAN to a device; wherein the apparatus is capable of processing the video into the bitstream such that the bitstream

(a) represents the video in a vector graphic format with quality labels which are device independent, and

(b) is decodable at the device to display, at a quality determined by the resource constraints of the device, a vector graphics based representation of the video; and in which the apparatus is programmed to perform the following as part of processing the video into a vector graphics format with quality labels:

(i) describe the video in terms of vector based graphics primitives;

(ii) group these graphics primitives into features;

(iii) assign to the graphics primitives and/or to the features values of perceptual significance;

(iv) derive quality labels from these values of perceptual significance.

In a fourth aspect, there is a device for decoding video which has been processed into an encoded bitstream in which the encoded bitstream has been be sent over a WAN to the devise;

wherein the device is capable of decoding the bitstream by (i) extracting quality labels which are device independent and (ii) displaying a vector graphics based representation of the video at a quality determined by the quality labels, so that the quality of the video displayed on the device is determined by the resource constraints of the device;

and in which the following steps occur as part of processing the video into a vector graphics format with quality labels:

(i) describing the video in terms of vector based graphics primitives;

(ii) grouping these graphics primitives into features;

(iii) assigning to the graphics primitives and/or to the features values of perceptual significance,

(iv) deriving quality labels from these values of perceptual significance.

In a fifth and final aspect, there is a video file bitstream which has been encoded by a process comprising the steps of processing an original video into an encoded bitstream in which the encoded bitstream is intended to be sent over a WAN to a device wherein the processing of the video results in the encoded bitstream:

(a) representing the video in a vector graphic format with quality labels which are device independent, and

(b) being decodable at the device to display, at a quality determined by the resource constraints of the device, a vector graphics based representation of the video;

and in which the following steps occurred as part of processing the video into a vector graphics format with quality labels:

(i) describing the video in terms of vector based graphics primitives;

(ii) grouping these graphics primitives into features;

(iii) assigning to the graphics primitives and/or to the features values of perceptual significance.

(iv) deriving quality labels from these values of perceptual significance.

Briefly, an implementation of the invention works as follows;

A grey-scale image is converted to a set of regions. In a preferred embodiment, the set of regions corresponds to a set of binary images such that each binary image represents the original image threshold at a particular value. A number of quantisation levels max_levels is chosen and the histogram of the input image is equalised for that number of levels, i.e., each quantisation level is associated with an equal number of pixels. Threshold values t(1), t(2), . . . , t(max_levels), where t is a value between the minimum and maximum value of the grey-scale, are derived from the equalisation step and used to quantize the image into max_levels binary images consisting of foreground regions (1) and background (0). For each of the max_levels image levels the following steps are taken: The regions are grown in order to fill small holes and so eliminate some ‘noise’. Then, to ensure that no ‘gaps’ open up in the regions during detection of their perimeters, any 8-fold connectivity of the background within a foreground region is removed, and 8-fold connected foreground regions are thickened to a minimum of 3-pixel width.

In another embodiment, the regions are found using a “Morphological Scale-Space Processor”; a non-linear image processing technique that uses shape analysis and manipulation to process multidimensional signals such as images. The output from such a processor typically consists of a succession of images containing regions with increasingly larger-scale detail. These regions may represent recognisable features of the image at increasing scales and can conveniently be represented in a scale-space tree, in which nodes hold region information (position, shape, colour) at a given scale, and edges represent scale-space behavior (how coarse-scale regions are formed from many fine-scale ones).

These regions may be processed into a description (the shape description) that describes the shape, colour, position, visual priority, and any other aspect, of the regions, in a compact manner. This description is processed to provide feature information, where a feature is an observable characteristic of the image. This information may include any of the following: the sign of the intensity gradient of the feature (i.e., whether the contour represents the perimeter of a filled region or a hole), the average intensity of the feature, and the ‘importance’ of the feature, as represented by this contour.

In a preferred embodiment, the perimeters of the regions are found, unique labels assigned to each contour, and each labelled contour processed into a list of coordinates. For each of the max_levels image levels, and for each contour within that level it is established whether the contour represents a boundary or a hole using a scan-line parity-check routine (Theo Pavlidis “Algorithms for Graphics and Image Processing”, Springer-Verlag, P.174). Then a grey-scale intensity is estimated and assigned to this contour by averaging the grey-scale intensities around the contour.

Finally, the contours are grouped into features by sorting the contours into families of related contours, and each feature is assigned a perceptual significance computed from the intensity gradient of the feature. Also, each contour within the feature is individually assigned a perceptual significance computed from the intensity gradient in the local of the contour. Quality labels are then derived from the values of perceptual significance for both the contours and features in order to enable detection of position in a quality hierarchy.

The contour coordinates may be sorted in order to put the coordinates in pixel adjacency order in order that, in the fitting step, the correct curves are modeled.

In the preferred embodiment of this aspect of the invention, the contour is split into a set of simplified curves that are single-valued functions of the independent variable x, i.e., the curves do not double-back on themselves, so a point with ordinate x is adjacent to a point with ordinate x+1.

Parametric curves may then be fitted to the contours.

In a preferred embodiment, a piecewise cubic Bezier curve fitting algorithm is used as described in: Andrew S. Glassier (ed), Graphics Gems Volume 1, P612, “An Algorithm for Automatically Fitting Digitised Curves”. The cures are priority-ordered to form a list of graphics instructions in a vector graphics format that allow a representation of the original image to be reconstructed at a client device.

For each level, starting with the lowest and for each contour representing a filled region, the curve is written to file in SVG format. Then, for each level starting with the highest, and for each contour representing a hole, the curve written to file in SVG format. This procedure adapts the well-known “painters algorithm” in order to obtain the correct visual priority for the regions. The SVG client renders the regions in the order in which they are written in the file: by rendering regions of increasing intensity order “back-to-front” and then rendering regions of decreasing intensity order “front-to-back” the desired approximation to the input image is reconstructed.

The region description may be transmitted to a client which decodes and reconstructs the video frames to a “base” quality level. A second encoding algorithm is then employed to generate enhancement information that improves the quality of the reconstructed image.

In a preferred embodiment, the segmented and vectorised image is reconstituted at the encoder at a resolution equivalent to the “root” quadrant of a quadtree decomposition. This is used as an approximation to, or predictor for, the true root data values. The encoder subtracts the predicted, from the true root quadrant, encodes the difference using a entropy encoding scheme, and transmits the result. The decoder performs the inverse function, adding the root difference to the reconstructed root, and using this as the start point in the inverse transform.

### BRIEF DESCRIPTION OF FIGURES

Note:—in the figures, the language used in the code fragments is MATLAB m-code.

FIG. 1 shows a code fragment for the ‘makecontours’ function.

FIG. 2 shows a code fragment for the ‘coutourtype’ function.

FIG. 3 shows a code fragment for the ‘contourcols’ function.

FIG. 4 shows a code fragment for the ‘contourassoc’ function

FIG. 5 shows a code fragment for the ‘contourgrad’ function.

FIG. 6 shows a code fragment for the ‘adjorder’ function.

FIG. 7 shows a code fragment for the ‘writebezier’ function.

FIG. 8 shows a flow chart representing the process of grouping contours into features.

FIG. 9 shows a flow chart representing the process of assigning values of perceptual significance to features and contours.

FIG. 10 shows a flow chart representing the process of assigning quality labels to contours.

FIG. 11 shows a diagram of the data structures used.

FIG. 12 shows the original monochrome ‘Saturn’ image

FIGS. 13-16 show the contours at levels 1-4, respectively.

FIG. 17 shows the contours at all levels superimposed.

FIG. 18 shows the rendered SVG image.

FIG. 19 shows a scalable encoder.

FIG. 20 shows a scalable decoder.

### BEST MODE FOR CARRYING OUT THE INVENTION

### Key Concepts

Scalable Vector Graphics

An example of a scalable vector file format is Scalable Vector Graphics (Scalable Vector Graphics (SVG) 1.0 Specification, W3C Candidate Recommendation, 2 Aug. 2000). SVG is a proposed standard format for vector graphics which is a namespace of XML and which is designed to work well across platforms, output resolutions, color spaces, and a range of available bandwidths, SVG.

Wavelet Transform

The wavelet transform has only relatively recently matured as a tool for image analysis and compression. Reference may for example be made to Mallat, Stephane G. “A Theory for Multiresolution Signal Decomposition: The Wavelet Representation” IEEE Transactions on Pattern Analysis and Machine Intelligence, vol. 11, No. 7, pp 674-692 (July 1989) in which the Fast Wavelet Transform (FWT) is described. The FWT generates a hierarchy of power-of-two images or subbands where at each step the spatial sampling frequency—the ‘fineness’ of detail which is represented—is reduced by a factor of two in x and y. This procedure decorrelates the image samples with the result that most of the energy is compacted into a small number of high-magnitude coefficients within a subband, the rest being mainly zero or low-value, offering considerable opportunity for compression.

Each subband describes the image in terms of a particular combination of spatial/frequency components. At the base of the hierarchy is one subband—the root—which carries the average intensity information for the image, and is a low-pass filtered version of the input image. This subband can be used in Scalable image transmission systems as a coarse-scale approximation to the input image, which, however, suffers from blurring and poor edge definition.

Scale-Space Filtering

The idea of scale-space was developed for use in computer vision investigations and is described in, for example, A. P. Witkin: Scale space filtering—A new approach to multi-scale description, Ullman, Richards (Eds.), Image Understanding, Ablex, Norwood, N.J., 79-95, 1984. In a multi-scale representation, structures at coarse scales represent simplifications of the corresponding structures at finer scales. A multi-scale representation of an image can be obtained by the wavelet transform, as described above, or convolution using a Gaussian kernel. However, such linear filters result in a blurring of edges at coarse scales, as in the case of the wavelet root quadrant, as described above.

Browse Quality

In certain applications, the ability quickly to gain a sense of structure and movement outweighs the need to render a picture as accurately as possible. Such a situation occurs when a human user of a video delivery system wishes to find a particular event in a video sequence, for example, during an editing session; here the priority is not to appreciate the image as an approximation to reality, but to find out what is happening in order to make a decision. In such situations a stylised, simplified, or cartoon-like representation is as useful as, and arguably better than, an accurate one, as long as the higher-quality vein is available when required.

Segmentation

In order to obtain a scale-space representation that simplifies or removes detail whilst preserving edge definition, a different approach must be taken to the problem of image simplification. Segmentation is the process of identifying and labelling regions that are “similar”, according to some relation. A segmented image replaces smooth gradations in intensity with sharply defined areas of constant intensity but preserves perceptually significant features, and retains the essential structure of the image. A simple and straightforward approach to doing this involves applying a series of thresholds to the image pixels to obtain constant intensity regions, and sorting these regions according to their scale (obtained by counting interior pixels, or other geometrical methods which take account of the size and shape of the perimeter). These regions, typically, will correlate poorly with perceptually significant features in the original image, but can still represent the original in a stylised way.

To obtain a better correlation between image features and segmented regions non-linear image processing techniques can be employed as described in, for example, P. Salembier and J. Sert, “Flat zones filtering, connected operators and filters by reconstruction”, IEEE Transactions on Image Processing, 3(8):1153-1160, August 1995, which describes a Morphological segmentation technique.

Morphological segmentation is a shape-based image processing scheme that uses connected operators (operators that transform local neighbourhoods of pixels) to remove and merge regions such that intra-region similarity tends to increase and inter-region similarity tends to decrease. This results in an image consisting of so-called “flat zones”: regions with a particular colour and scale. Most importantly, the edges of these flat zones are well-defined and correspond to edges in the original image.

A specific embodiment of the invention will now be described by way of example.

Conservation of Input Image to Set of Binary Images Representing Regions

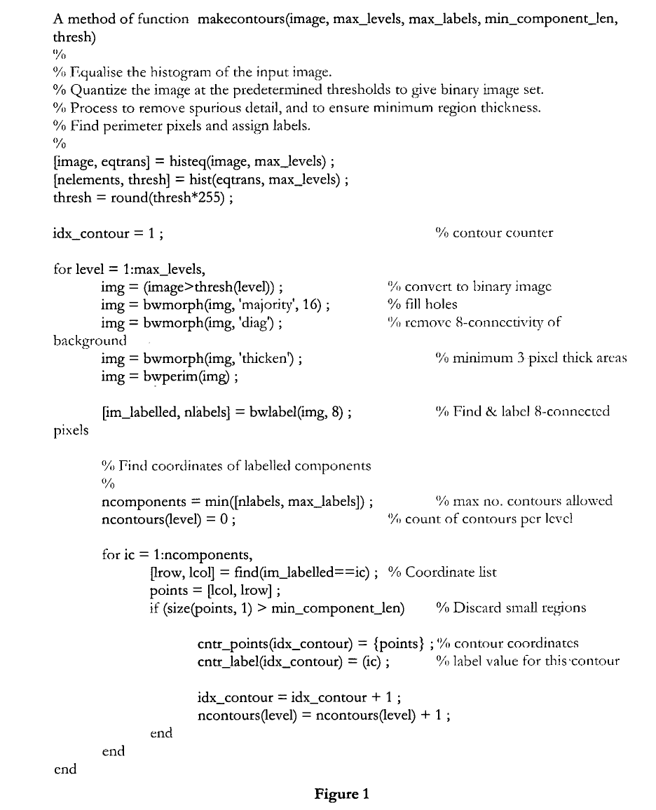

Referring to the code fragment of FIG. 1, a number of quantisation labels max_levels is chosen and the histogram of the input image is equalised for that number of levels. The equalisation transform matrix is then used to derive a vector of threshold values and this vector is used to quantise the image into max_levels levels. The histogram of the resulting quantised image is flat (i.e. each quantisation level is associated with an equal number of pixels). Then, for each of the max_levels levels, the image is threshold at level L to convert to a binary image, consisting of foreground regions (1) and background (0).

Conversion of Binary Images to Coordinate Lists Representing Contours

Referring again to the code fragment of FIG. 1, for each of the max_levels binary images the following steps arc taken: The regions are grown in order to fill small holes and so climinate some ‘noise’. The ‘grow’ operation involves setting a pixel to ‘1’ if five or more pixels in the 3-by-3 neigbbourhood are ‘1’s; otherwise it is set to ‘0’.

Then, to insure that no gaps open up in the regions during subsequent processing, any 8-fold connectivity of the background is removed using a diagonal fill, and 8-fold connected foreground regions are widened to a minimum 3-pixel span using a thicken peration that adds pixels to the exterior of regions. The perimeters of the resulting regions are located and a new binary image created with pixels set to represent the perimeters. Each set of 8-connected pixels is then located and overwritten with a unique label. Then every connected set of pixels with a particular label is found and a list of pixel coordinates is built

Determination of Contour Colour and Type

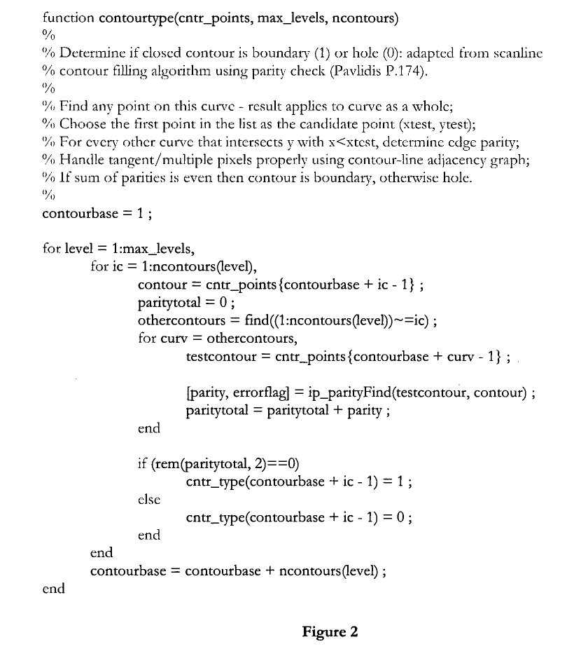

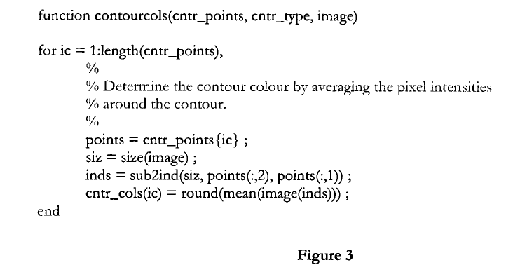

Referring to the code fragment of FIG. 2, for each of the max_levels image levels, and for each contour within that level it is established whether the contour represents a fill or a hole at this level using a scan-line parity-check routine (Theo Pavlidis “Algorithms for Graphics and Image Processing”, Spriger-Verlag, P.174). Then, referring to the code fragment of FIG. 3, for each contour a grey-scale intensity is estimated and assigned to this contour by averaging the grey-scale intensities around the contour.

Feature Extraction and Quality Labelling from Contours

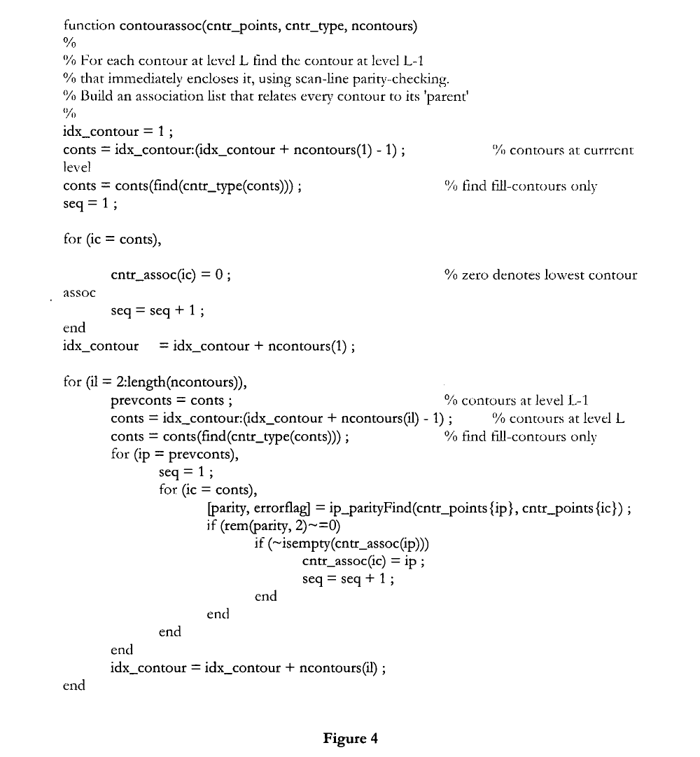

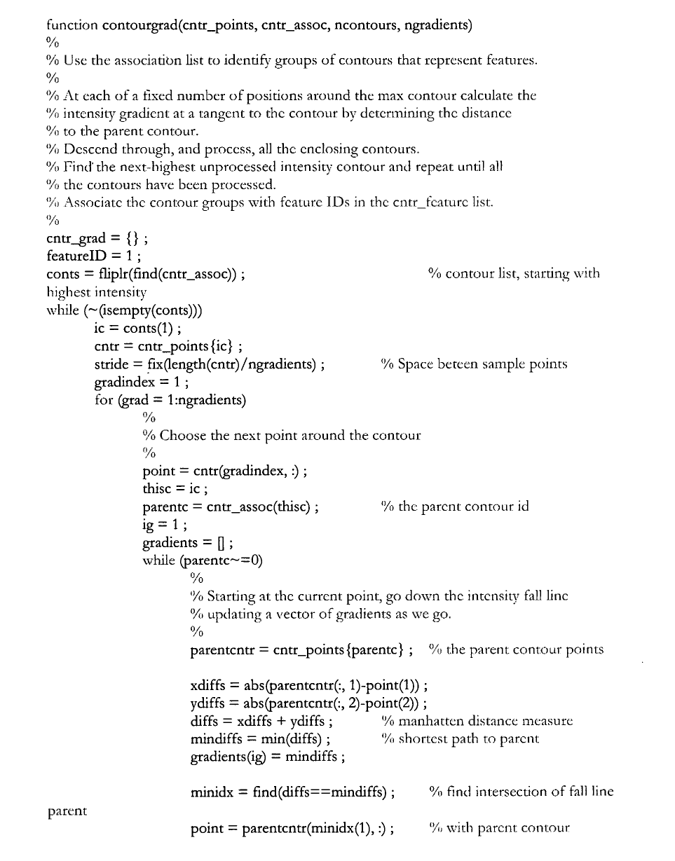

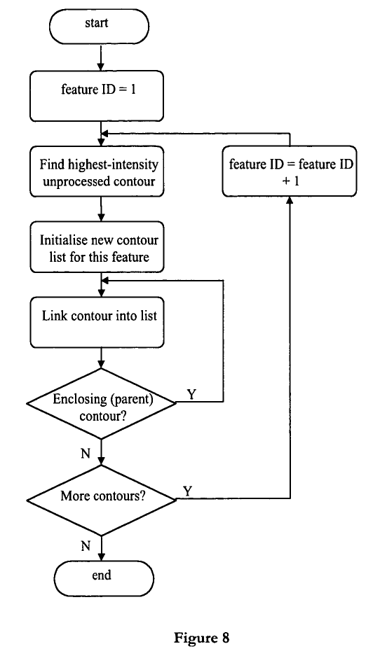

The contours are grouped into features where each feature is assigned a perceptual significance computed from the intensity gradients of the feature. Also, each contour within the feature is individually assigned a perceptual significance computed from the intensity gradient in the locality of the contour. This is done as follows. Referring to the code fragment of FIG. 4 and the flow-chart of FIG. 8: starting with the highest-intensity fill-contour (rather than hole-contour), each contour at level L is associated with the contour at level L-1 that immediately encloses it, again using scan-line parity-checking. An association list is built that relates every contour to its ‘parent’ contour so that groups of contours representing a feature can be identified. The feature is assigned an ID and a reference to the contour list is made in a feature table. The process is then repeated for hole-contours, starting with the one with the lowest-intensity.

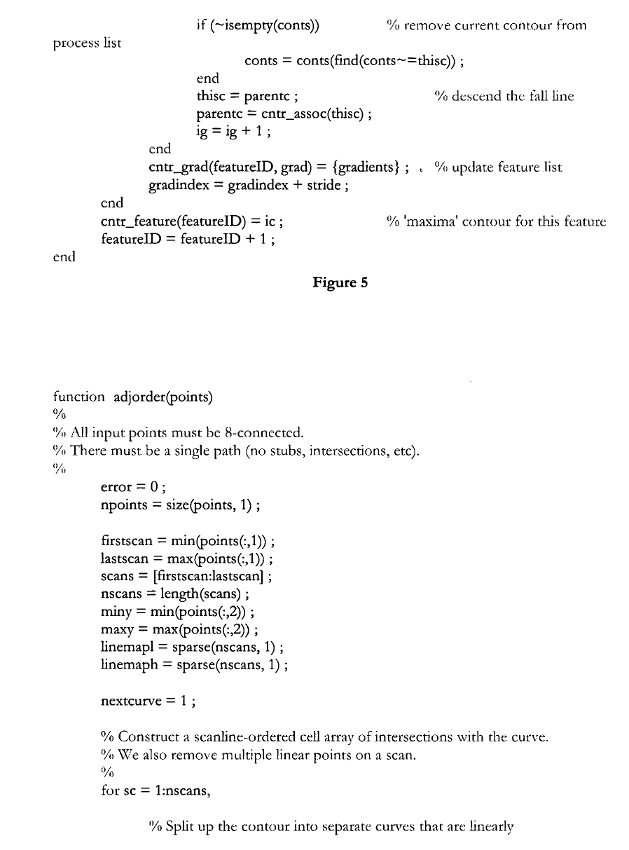

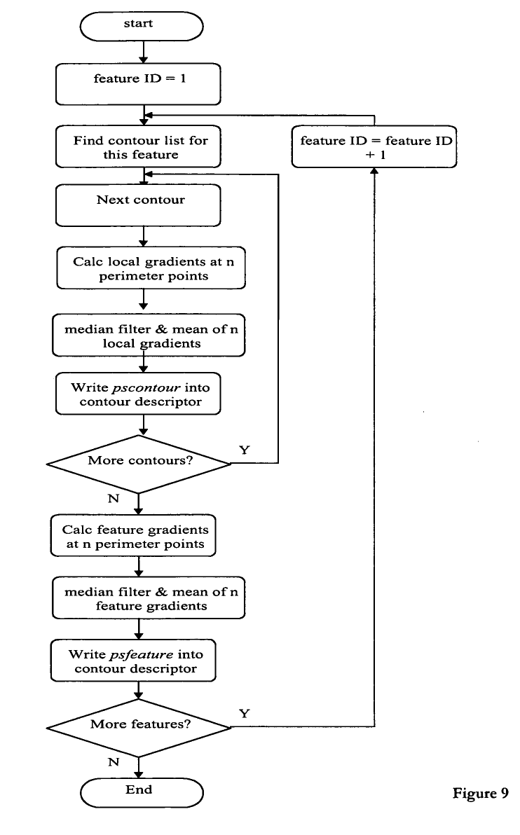

Referring to the code fragment of FIG. 5 and the flow-chart of FIG. 9, perceptual significances are then assigned to features and contours in the following way. Starting with the highest-intensity fill-contour of a feature, and at each of a fixed number of positions (termed the fall-lines) around this contour, the intensity gradient is calculated by determining the distance to the patent contour. These gradients are median-filtered and averaged and the value thus obtained—pscontour—gives a reasonable indication of perceptual significance of the contour. The association list is used to descend through all the rest of the enclosing contours. Then the gradients down each of the fall-lines of all the contours for the feature are calculated, median-filtered and averaged, and the value thus obtained—psfeature—gives a reasonable indication of perceptual significance of the feature as a whole.

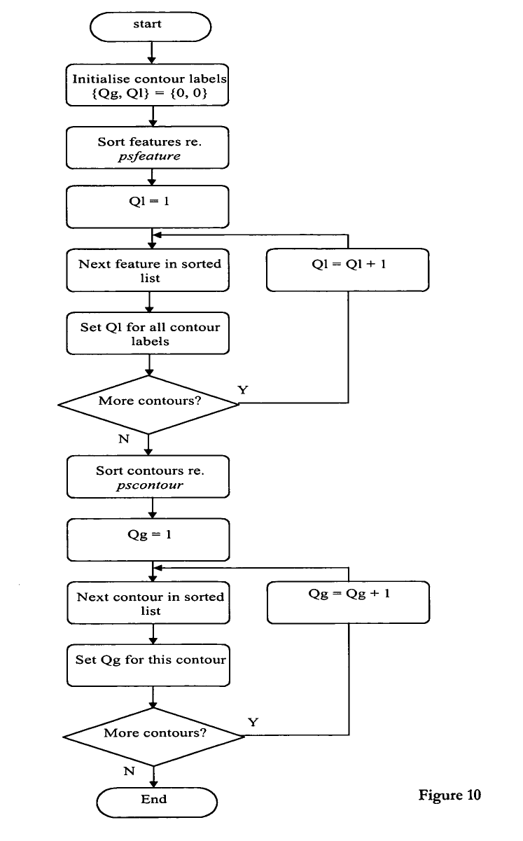

The final step is to derive quality labels from the values of perceptual significance for the contours and features in order to enable determination of position in a quality hierarchy. Referring to the flowchart of FIG. 10, quality labels are initialised as the duple {Ql, Qg} (local and global quality) on each contour descriptor. The features are sorted with respect to psfeature. The first (most significant) feature is found and all of the contour descriptors in its list have their Ql set to 1; then the next most significant feature is found and the contour descriptors have their Ql set to 2, and so on. Thus, all the contours within a feature have the same value of Ql; contours belonging to different features have different values of Ql.

As a second step all the contours are sorted with respect to pscontour, and linearly increasing values of Qg, starting with 1, are written to their descriptors. Thus, every contour in the scene has a unique value of Qg.

Two orderings of the data are thus obtained using the quality labels: Ql ranks localised image features into significance order, Qg ranks contours into global significance order. This allows a decoder to choose the manner in which a picture is reconstructed: whether to bias in favour of reconstructing individual local features with the best fidelity first, or obtaining a global approximation to the entire scene first.

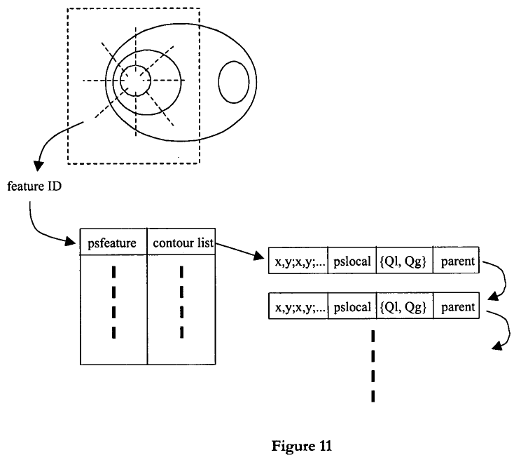

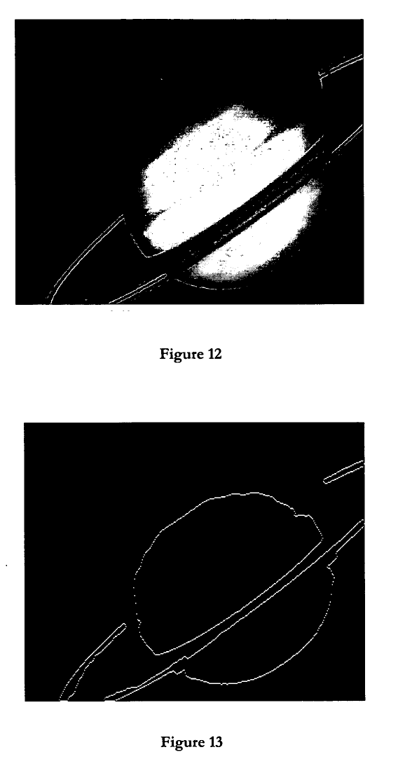

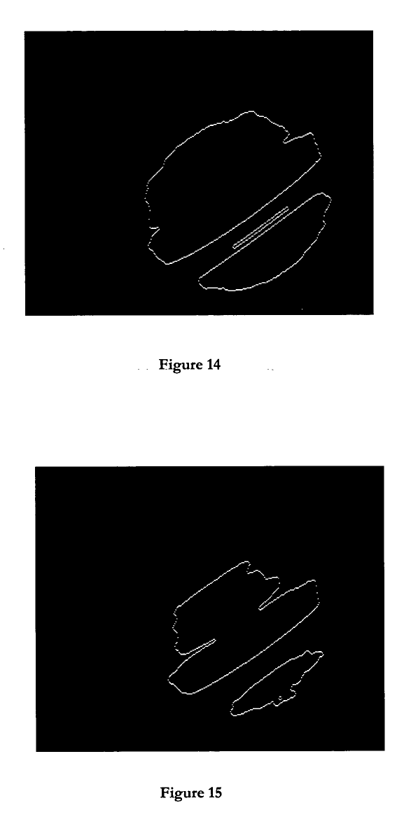

The diagram of FIG. 11 outlines the data structures used when assigning, quality labels to contours. The feature indicated comprises three contours. Local and global gradients are computed using the eight fall-lines shown and the values psfeature, pscontour, Qg, and Ql arc written in the tables.

Reordering and Filtering of Contours

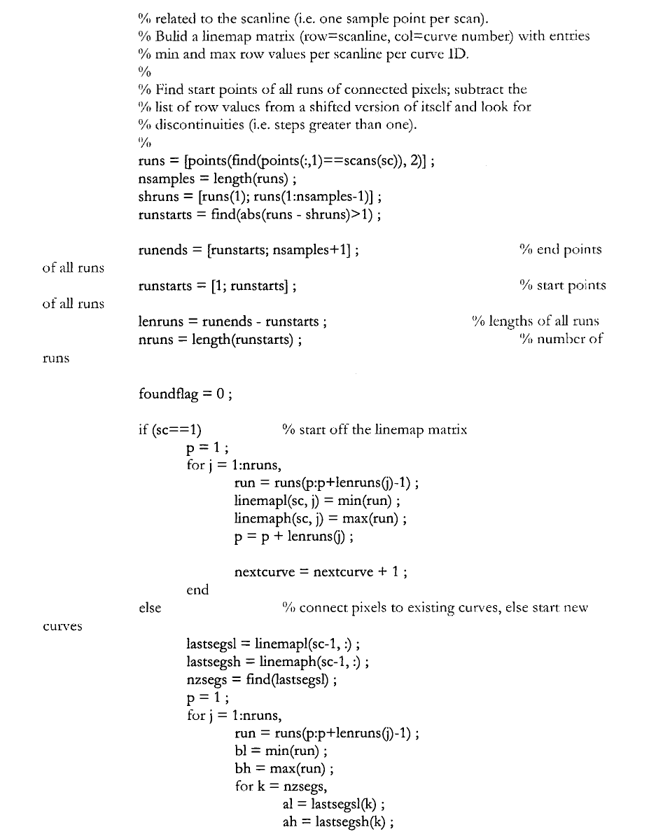

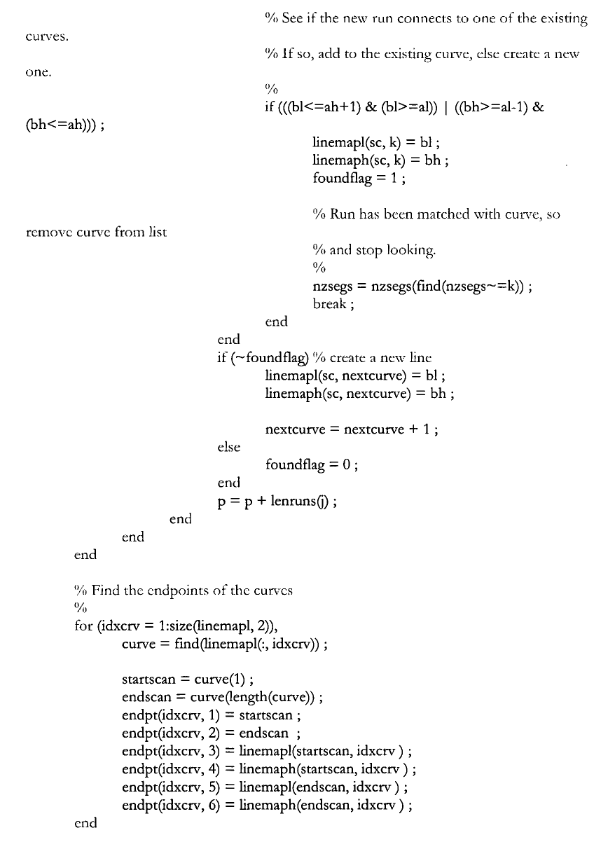

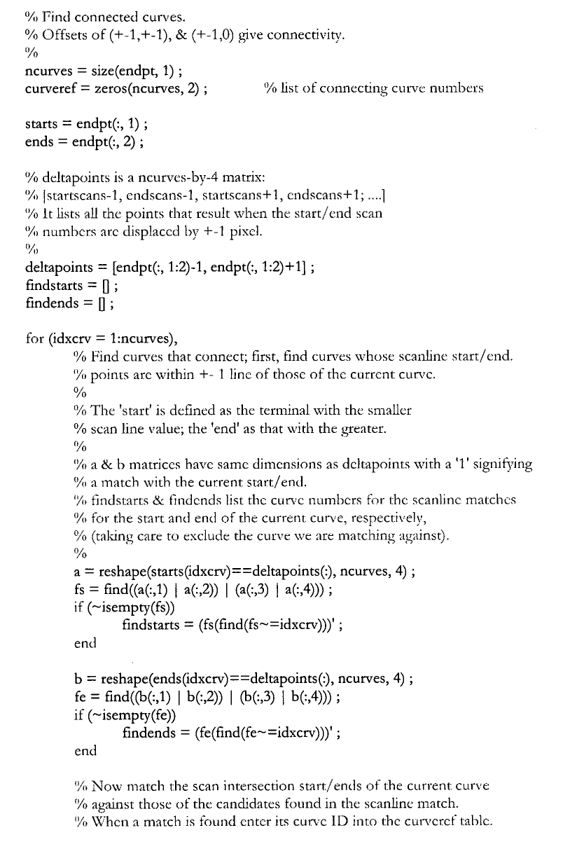

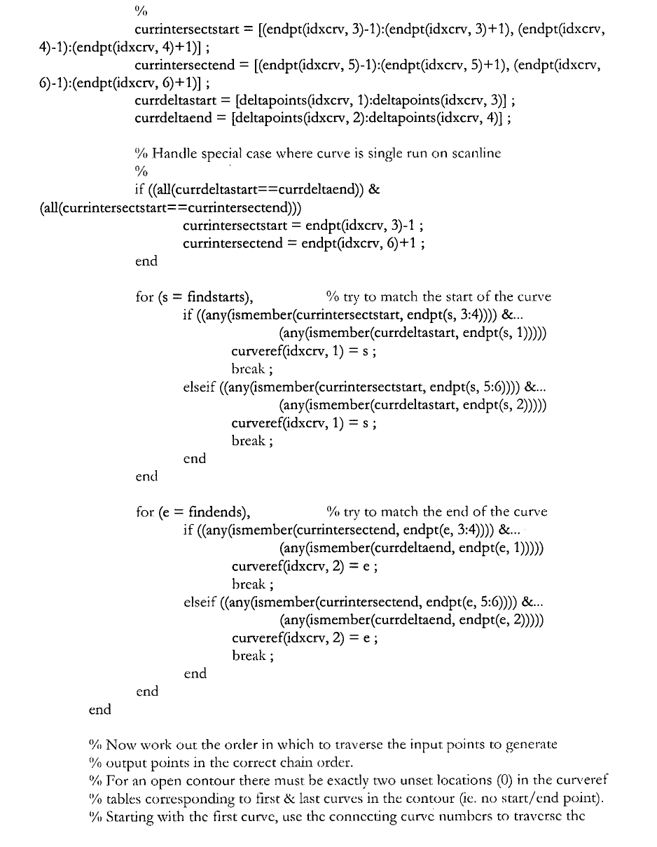

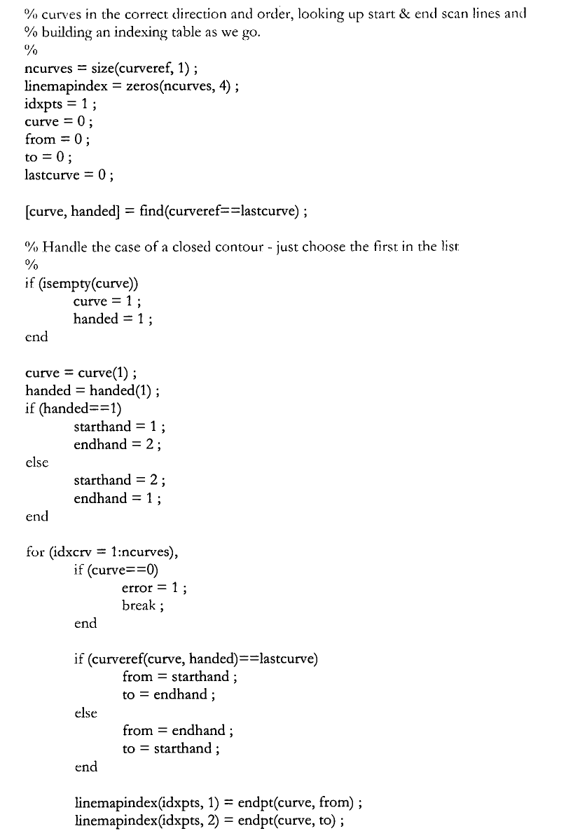

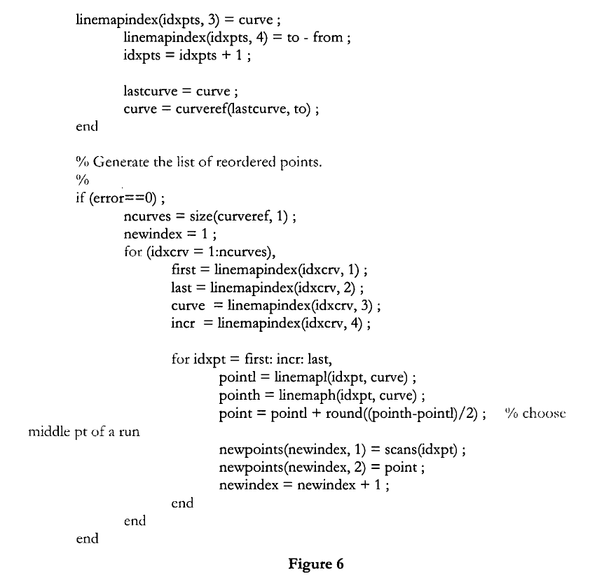

After the previous operations have been completed the coordinates in each list are in scan-order, i.e., the order in which they were detected. In order for curve-fitting to work they need to be re-ordered such that each coordinate represents a pixel adjacent to its immediate 8-fold connected neighbour. Referring to the code fragment of FIG. 6—of the independent variable, i.e., that never change direction with respect to increasing this is done as follows: The contour may be complicated, with many changes of direction but it cannot cross itself, or have multiple paths. The algorithm splits the contour into a list of simpler curves that are single-valued functions scan number (or x-value). On these curves each value of the independent variable x maps to just one point, so points at x(n) and x(n+1) must be adjacent. The start and finish points of these curves are found, then for each curve these points are tested against all others to determine which curve connects to which other(s). Finally, the curves are traversed in connection order to generate the list of pixel coordinates in adjacency order. As part of the reordering process, runs of pixels on the same scan line are detected and replaced by a single point to reduce the size of data handed on to the fitting process.

Bezier Curve Fitting

The piecewise cubic Bezier curve fitting algorithm used in the preferred embodiment of the invention is described in; Andrew S. Glassier (ed), Graphics Gems Volume 1, P612, “An Algorithm for Automatically Fitting Digitised Curves”.

Visual Priority Ordering

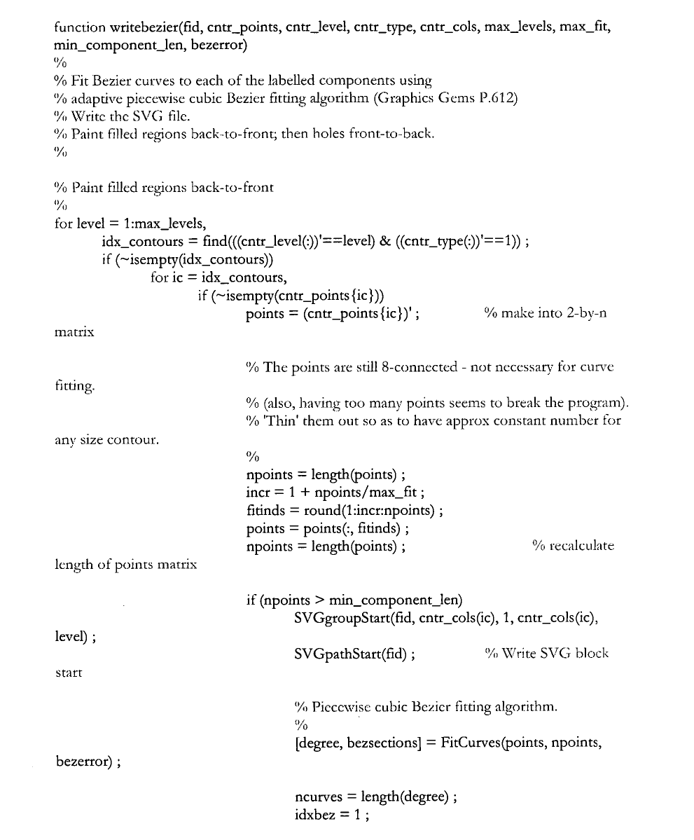

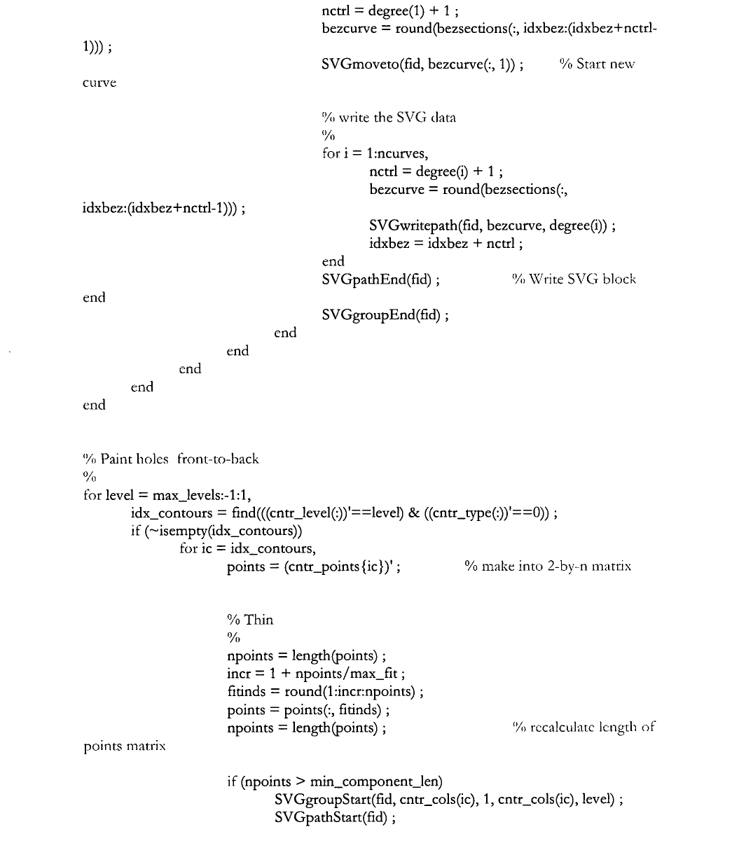

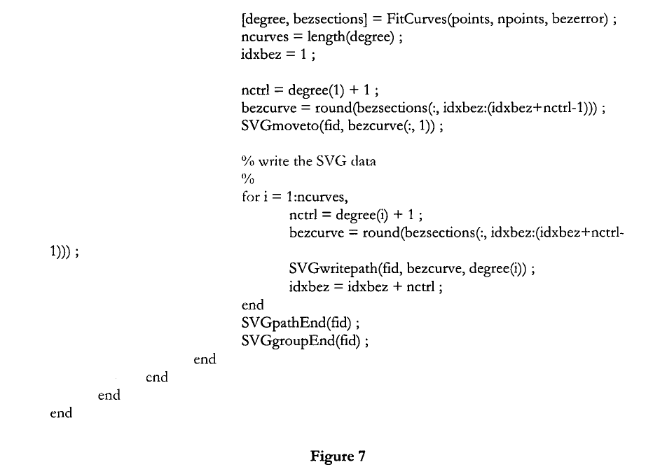

Referring to the code fragment of FIG. 7, for each level starting with the lowest, and for each contour representing a filled region, the curve is to file in SVG format. Then, for each level starting with the highest, and for each contour representing a hole the curve written to file in SVG format. This procedure adapts the well-known “painters algorithm” in order to obtain the correct visual priority for the regions. The SVG client renders the regions in the order in which they are written in the file: by rendering regions of increasing intensity order “back-to-front” and then rendering regions of decreasing intensity order “front-to-back” the desired approximation to the input image is reconstructed.

Scalable Encoding Using a Vector Graphics Base Level Encoding

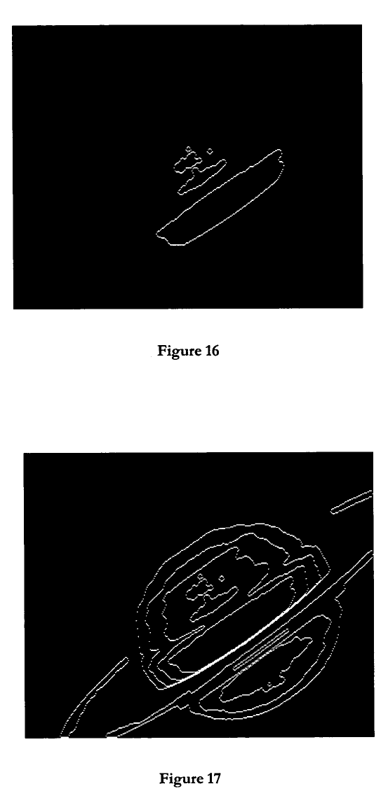

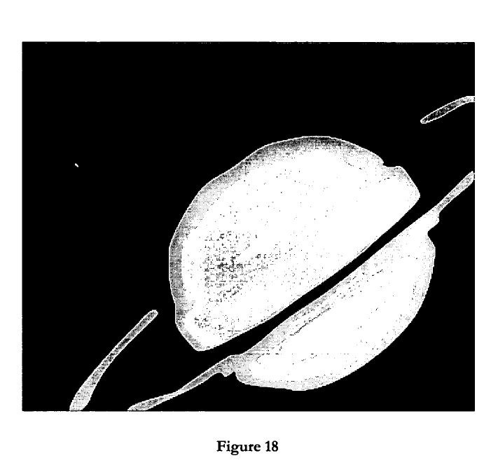

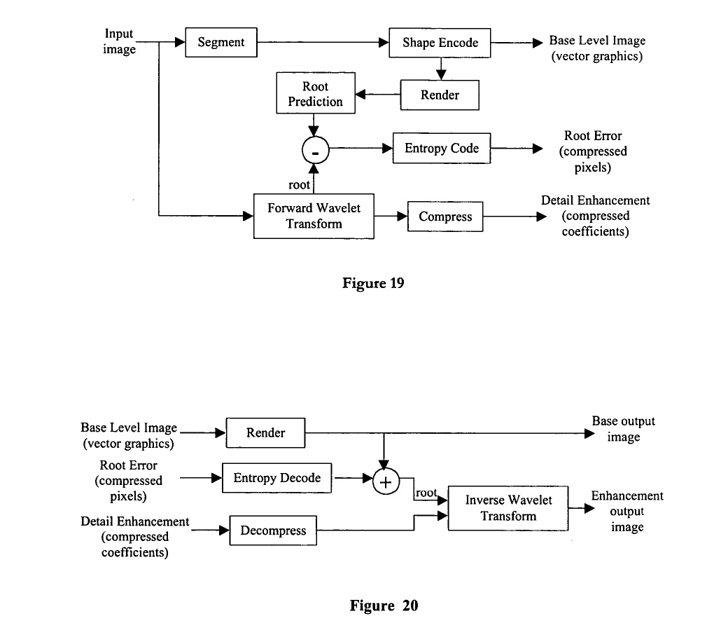

Referring to the diagrams of a scalable encoder and decoder (FIGS. 15 and 16), at the encoder the input image is segmented, shape-encoded, converted to vector graphics and transmitted as a low-bitrate base level image; it is also rendered at the wavelet root quadrant resolution and used as a predictor for the root quadrant data. The error in this prediction is entropy-encoded and transmitted together with the compressed wavelet detail coefficients. This compression may be based on the principle of spatially oriented trees, as described in PCT/GB00/01614 to Telemedia Limited. The decoder performs the inverse function; it renders the root image and presents this as a base level image; it also adds this image to the root difference to obtain the true root quadrant data which is then used as the start point for the inverse wavelet transform.

Industrial Applicability

As a simple example of the use of the invention consider the situation in which it is desired that material residing on a picture repository be made available to a range of portable devices with displays with an assortment of spatial and grey-scale resolution—possibly some with black-and-white output only. Using the methods of the current invention the material is processed into a single file in SVG format. The devices are loaded with SVG viewer software that allows reconstruction of picture data irrespective of the capability of the individual client device.

1. A method of processing video into an encoded bitstream in which the encoded bitstream is intended to be sent over a WAN to a device, wherein the processing of the video results in the bitstream:
(a) representing the video in a vector graphic format with quality labels which are device independent, and
(b) being decodable at the device to display, at a quality determined by the resource constraints of the device, a vector graphics based representation of the video;
and in which the following steps occur as part of processing the video into a vector graphics format with quality labels:
(i) describing the video in terms of vector based graphics primitives;
(ii) grouping these graphics primitives into features;
(iii) assigning to the graphics primitives and/or to the features values of perceptual significance;
(iv) deriving quality labels from these values of perceptual significance.

2. The method of claim 1 in which the quality labels enable scalable reconstruction of the video at the device and also at different devices with different display capabilities.

3. The method of claim 1 in which multiple processing steps arc applied to the video, with each processing step producing an encoded bitstream with different quality characteristics.

4. The method of claim 1 in which the vector based graphics primitives are selected from the group comprising:
(a) straight lines or
(b) curves.

5. The method of claim 1 in which the values of perceptual significance relate to one or more of the following:
(a) individual local features;
(b) a global approximation to an entire scene in the video.

6. The method of claim 1 in which the values of perceptual significance relate to one or more of the following:
(a) sharpness of an edge
(b) size of an edge
(c) type of shape
(d) colour consistency.

7. The method of claim 1 in which the video is an image and/or image sequence.

8. The method of claim 1 where the video constitutes the base level in a scalable image delivery system, and where the features represented by graphics primitives in the video have a simplified or stylised appearance, and have well defined edges.

9. The method of claim 8 where the image processing involves converting a grey-scale image into a set of binary images obtained by thresholding.

10. The method of claim 8 where the processing involves converting a grey-scale image into a set of regions obtained using morphological processing.

11. The method of claim 8 or 9, where the processing further involves the steps of region processing to eliminate detail perimeter determination, and processing into a coordinate list.

12. The method of claim 11 where the processing further involves the generation of perceptual significance information for both the graphics primitives and features, that are used to derive quality labels, that enable determination of position in a quality hierarchy.

13. The method of claim 12 where the processing further involves re-ordering of the list such that each coordinate represents a pixel adjacent to its immediate 8-fold connected neighbour.

14. The method of claim 13 where the processing further involves fitting parametric curves to the contours.

15. The method of claim 14 where the processing further involves priority-ordering the contour curves representing filled regions front-to-back, and contour curves representing holes back-to-front, in order to form a list of graphics instructions in a vector graphics format that allow a representation of the original image to be reconstructed at a client device.

16. A method of decoding video which has been processed into an encoded bitstream in which the encoded bitstream has been be sent over a WAN to device;
wherein the decoding of the bitstream involves (i) extracting quality labels which are device independent and (ii) enabling the device to display a vector graphics based representation of the video at a quality determined by the quality labels, so that the quality of the video displayed on the device is determined by the resource constraints of the device and in which the following steps occurred as part of processing the video into a vector graphics format with quality labels:
(i) describing the video in terms of vector based graphics primitives;
(ii) grouping these graphics primitives into features;
(iii) assigning to the graphics primitives and/or to the features values of perceptual significance;
(iv) deriving quality labels from these values of perceptual significance.

17. An apparatus for encoding video into an encoded bitstream in which the encoded bitstream is intended to be sent over a WAN to a device, wherein the apparatus is capable of processing the video into the bitstream such that the bitstream:
(a) represents the video in a vector graphic format with quality labels which are device independent, and
(b) is decodable at the device to display, at a quality determined by the resource constraints of the device, a vector graphics based representation of the video;
and in which the apparatus is programmed to perform the following as part of processing the video into a vector graphics format with quality labels:
(i) describe the video in terms of vector based graphics primitives;
(ii) group these graphics primitives into features;
(iii) assign to the graphics primitives and/or to the features values of perceptual significance;
(iv) derive quality labels from these values of perceptual significance.

18. A device for decoding video which has been processed into an encoded bitstream in which the encoded bitstream has ben be sent over a WAN to the device;
wherein the device is capable of decoding the bitstream by (i) extracting quality labels which are device independent and (ii) displaying a vector graphics based representation of the video at a quality determined by the quality labels, so that the quality of the video displayed on the device is determined by the resource constraints of the device;
and in which the following steps occurred as part of processing the video into a vector graphics format with quality labels:
(i) describing the video in tens of vector based graphics primitives;
(ii) grouping these graphics primitives into features;
(iii) assigning to the graphics primitives and/or to the features values of perceptual significance;
(iv) deriving quality labels from these values of perceptual significance.

19. A video file bitstream which has been encoded by a process comprising the steps of processing an original video into an encoded bitstream in which the encoded bitstream is intended to be sent over a WAN to n device; wherein the processing of the video results in the encoded bitstream:
(a) representing the video in a vector graphic format with quality labels which are device independent, and
(b) being decodable at the device to display, at a quality determined by the resource constraints of the device, a vector graphics based representation of the video;
and in which the following steps occurred as part of processing the video into a vector graphics format with quality labels:
(i) describing the video in terms of vector based graphics primitives;
(ii) grouping these graphics primitives into features;
(iii) assigning to the graphics primitives and/or to the features values of perceptual significance;
(iv) deriving quality labels from these values of perceptual significance.
